(19) United States
(12) Patent Application Publication
(10) Pub. No.: US 2014/0374577 A1
(43) Pub. Date: Dec. 25, 2014

(54) OPTICAL POWER MEASUREMENT DEVICE

(71) Applicants: Kevin G. CASSADY, Monroe, WA (US); Eric THOMPSON,, Bothell, WA (US); Matthew BROWN, Mooresville, NC (US); Craig BLACK, Seattle, WA (US); Scott DEVORE, Kirkland, WA (US); Samuel S. FRANK, Seattle, WA (US); Alex HAY, Bothell, WA (US)

(72) Inventors: Kevin G. Cassady, Monroe, WA (US); Eric THOMPSON, Bothell, WA (US); Matthew BROWN, Mooresville, WA (US); Craig BLACK, Seattle, WA (US); Scott DEVORE, Kirkland, WA (US); Samuel S. FRANK, Seattle, WA (US); Alex HAY, Bothell, WA (US)

(21) Appl. No.: 14/313,146

(22) Filed: Jun. 24, 2014

Related U.S. Application Data
(60) Provisional application No. 61/838,593, filed on Jun. 24, 2013.

(51) Int. Cl. G01J 1/04

(52) U.S. Cl. CPC G01J 1/0403; G01J 1/0425
USPC 250/227.11; 250/216

(57) ABSTRACT

An optical power meter including a mechanical interface that establishes a predetermined air gap, while avoiding physical contact with the sensitive area of the DUT. The mechanical interface is formed such that the test instrument contacts the DUT in the non-sensitive region over an area large enough to establish contact pressure that is well within the strength of the DUT's material. Accordingly, the non-contacting optical element enables optical power to be collected and relayed with a quantifiable and repeatable power loss. A high-NA, large area optical element is used to collect and relay optical power accurately while maintaining low sensitivity to axial or radial alignment.

### CROSS-REFERENCE TO RELATED APPLICATIONS

The present application claims priority from U.S. Provisional Patent Application No. 61/838,593, entitled “Optical Power Measurement Device” filed Jun. 24, 2013, which is incorporated herein by reference in its entirety.

### TECHNICAL FIELD

The present disclosure relates to an optical power measurement device, and in particular to a small form factor optical power measurement device with a test ferrule for engaging a device under test without directly contacting optically sensitive areas.

### BACKGROUND

Direct measurement of optical power from cable terminations situated within bulkheads or devices is not feasible with conventional optical power meters (OPMs) because conventional OPMs are too large to fit in the allowed space. A typical solution is to relay power to an OPM via a “reference cable”, which makes physical contact at the device under test (DUT) and is coupled to an optical sensor at the OPM. Reference cables, however, are prone to breakage, loss and contamination. They further add uncertainty and complexity to the measurement process. Moreover, physical contact between the reference cable and the DUT increases the risk of damaging or contaminating the DUT. In view of the foregoing, there are significant problems and shortcomings with current technologies in direct measurement of optical power measurement devices.

### SUMMARY OF THE INVENTION

Accordingly, the present invention relates to an optical power measurement device for measuring optical power of a source of light from a device under test (DUT) comprising: a test instrument having a longitudinal optical axis and including: an optical element for transmitting test light, formed from at least a portion of the source of light; and a ferrule surrounding the optical element; and a photodetector for measuring the test light optically coupled to the optical element; wherein the ferrule includes: a first contact surface for abutting against a second contact surface on the DUT, parallel to the first contact surface, and a non-contact surface spaced from an optically transmitting area of the DUT by an air gap when the first and second contact surfaces are abutting, the non-contact surface including an optically receptive area formed by an end of the optical element for receiving the test light from an optically transmitting area of the DUT.

Another aspect of the present invention relates to an optical power measurement device for measuring optical power of a source of light from a device under test (DUT) comprising: a test instrument having a longitudinal optical axis and including a ferrule; and a photodetector mounted within the ferrule for measuring test light, formed from at least a portion of the source of light; wherein the ferrule includes: a first contact surface for abutting against a second contact surface on the DUT, parallel to the first contact surface, and a non-contact surface spaced from an optically transmitting area of the DUT by an air gap when the first and second contact surfaces are abutting, the non-contact surface including an optically receptive area formed by an end of the optical element for receiving the test light from an optically transmitting area of the DUT.

### BRIEF DESCRIPTION OF THE DRAWINGS

The invention will be described in greater detail with reference to the accompanying drawings which represent preferred embodiments thereof, wherein:

FIG. 1a depicts a cross-sectional view of an optical power meter (OPM) of the present invention engaging a device under test (DUT);

FIG. 1b depicts an enlarged view of area A from FIG. 1a;

FIG. 1c depicts an isometric view of the end of the probe from the OPM of FIG. 1a;

FIG. 2a depicts a cross-sectional view of an alternate embodiment of an optical power meter (OPM) of the present invention engaging a device under test (DUT);

FIG. 2b depicts an enlarged view of area A from FIG. 2a;

FIG. 2c depicts an isometric view of the end of the probe from the OPM of FIG. 2a;

FIG. 3 depicts an isometric view of a probe from an alternate embodiment of an optical power meter of the present invention, including an enlarged view of the end;

FIG. 4 depicts an isometric view of a probe from an alternate embodiment of an optical power meter of the present invention, including an enlarged view of the end;

FIG. 5 depicts an isometric view of a probe from an alternate embodiment of an optical power meter of the present invention, including an enlarged view of the end;

FIG. 6 depicts a cross-sectional view of a probe from an alternate embodiment of an optical power meter of the present invention;

FIG. 7 depicts a cross-sectional view of a probe from an alternate embodiment of an optical power meter of the present invention; and

FIG. 8 depicts a cross-sectional view of a probe from an alternate embodiment of an optical power meter of the present invention.

### DETAILED DESCRIPTION

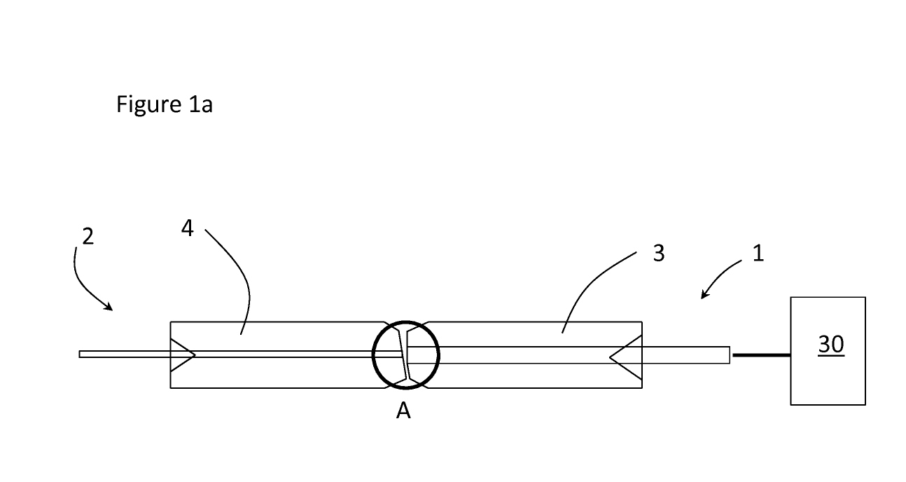

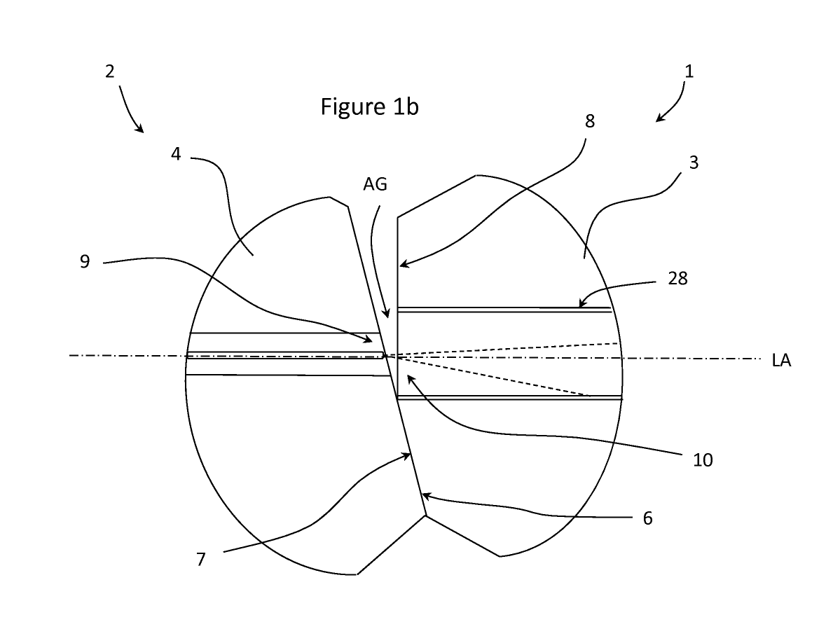

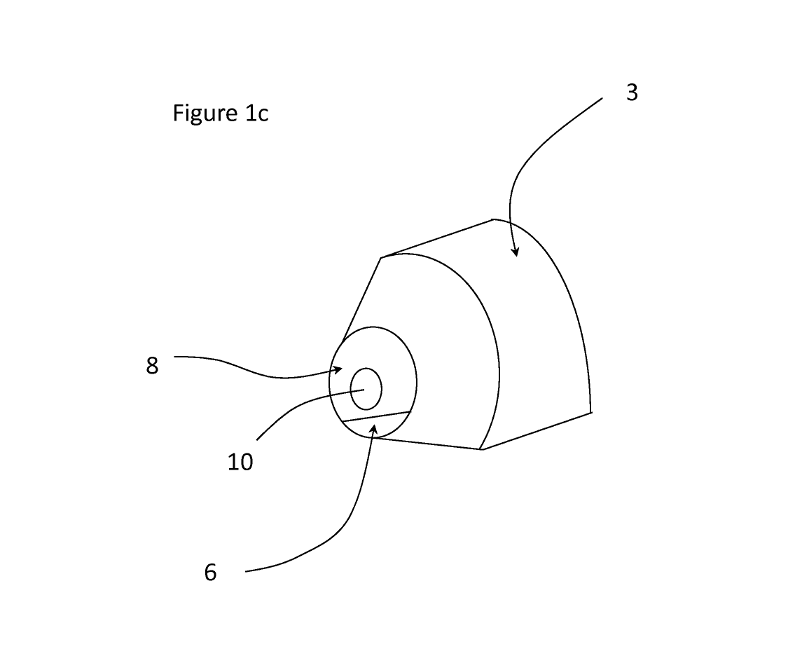

With reference to FIGS 1a, 1b and 1c, a test instrument, generally indicated at 1, of the present disclosure is comprised of two main components, one mechanical and one optical. The mechanical component may be a unique configuration of the instrument's ferrule geometry, which enables the system to maintain a consistent and controllable air gap AG between the test instrument 1 and a device under test (DUT) 2 in the most sensitive region of the DUT 2. Accordingly, a test ferrule 3 may be provided with an end face configuration, such that there may be near planar contact between the test instrument 1 and the DUT 2 in at least one mating non-sensitive region, thereby limiting stress/pressure at an optical interface.

The test ferrule 3 is shaped to engage and receive an optical signal from a DUT ferrule 4, which may have an end face polished at an angle, e.g. at 8°, from normal (APC), i.e. from a plane perpendicular to an optical axis of the DUT 2. Accordingly, the generally circular end face of the test ferrule 3 may comprise: 1) a first planar contact surface 6 parallel to the end face of the DUT ferrule 4, for mating with a planar non-sensitive area 7 of the end face of the DUT ferrule 4, and 2) a second non-contact surface 8 sloping away at an acute angle from the first contact surface 6 defining a wedge-shaped air gap AG, e.g. 5° to 15°, but ideally at an 8° angle, between an optically transmitting sensitive area 9 of the end face of the DUT ferrule 4 and an optical receptive section 10 of an optical element 28 in the end face of the test ferrule 3. In the illustrated first embodiment, the first contact surface 6 may be polished at the same angle from the second non-contact surface 8, as the end face of the DUT ferrule 4 is from normal, e.g. 8°. Ideally, the second non-contact surface 8 may be flat, i.e. perpendicular to the longitudinal optical axis of the DUT 2 and the test ferrule 3; however, both the first and second surfaces 6 and 8, respectively, could be angled, e.g. 5° to 15°, relative to the normal or flat surface, as long as the appropriate gap AG is provided between the sensitive area 9 and the optical receptive section 10.

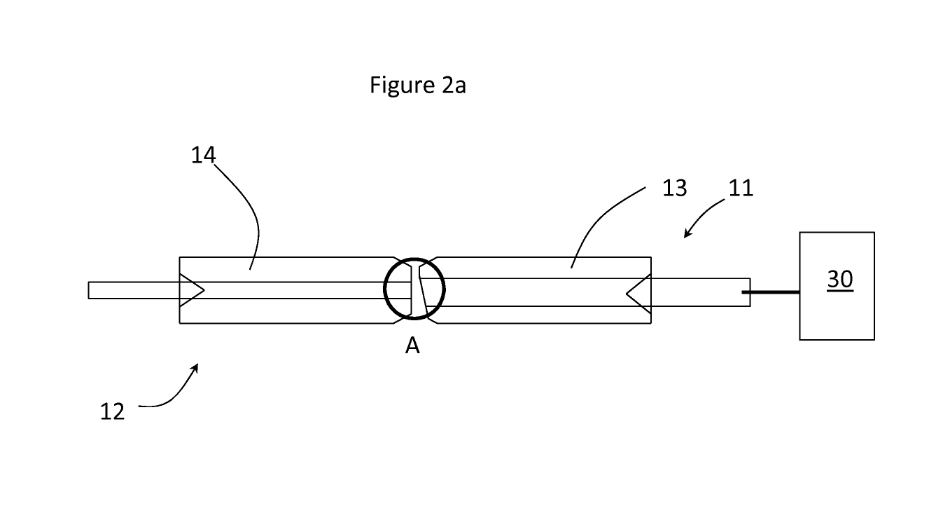

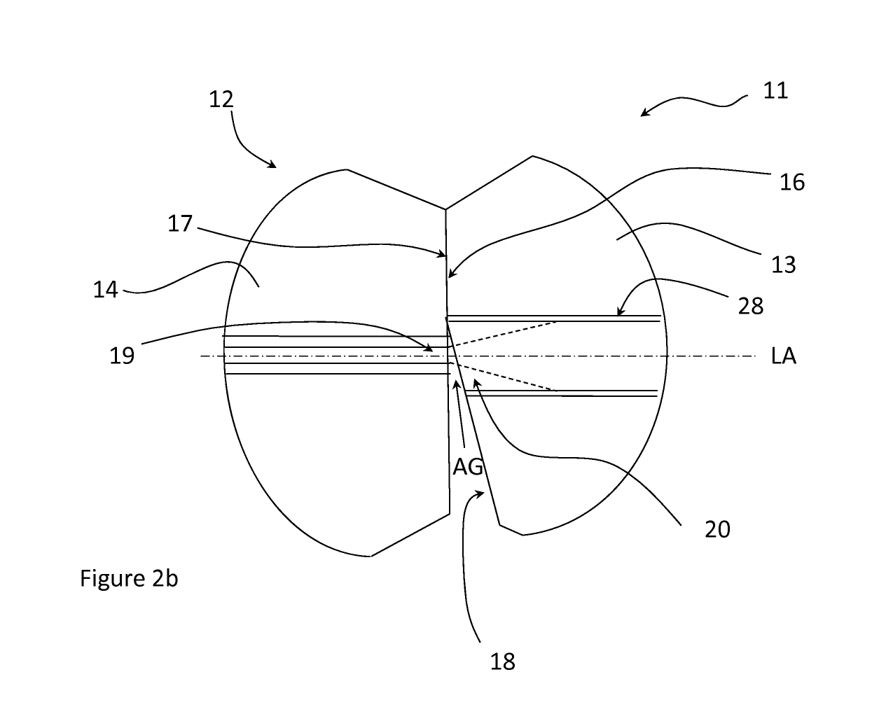

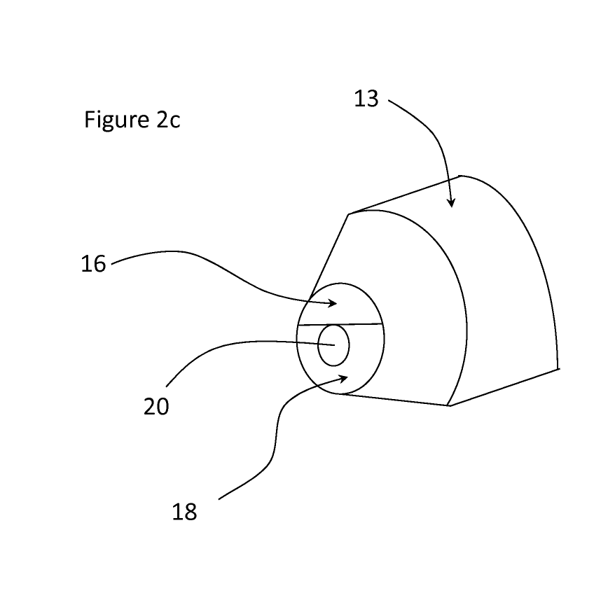

With reference to FIGS. 2a, 2b and 2c, a test instrument 11 includes a test ferrule 13, which may be shaped to function with a DUT 12, including a DUT ferrule 14, which has an end face polished normal (perpendicular) to the DUT's longitudinal center axis (LA) (Flat). Accordingly, the generally circular end face of the test ferrule 13 comprises: 1) a planar first contact surface 16 parallel to the end face of the DUT ferrule 14, for mating with a planar non-sensitive area 17 of the end face of the DUT ferrule 14, and 2) a second non-contact surface 18 sloping away at an acute angle from the first contact surface 16 defining a wedge-shaped air gap AG, e.g. 5° to 15°, but ideally at an 8° angle, between an optically transmitting sensitive area 19 of the end face of the DUT ferrule 14 and an optical receptive section 20 of the optical element 28 in the end face of test ferrule 13. In the illustrated embodiment, the second non-contact surface 18 may be at an angle from the first contact surface 16, e.g. 5° to 15°, ideally 8°, providing the appropriate air gap AG between the sensitive area 19 and the optically receptive section 20. Ideally the first contact surface 16 may be flat, i.e. perpendicular to the longitudinal optical axis LA of the DUT 14 and the test ferrule 13; however, both the first and second surfaces 16 and 18, respectively, could be angled, e.g. 5° to 15°, relative to the normal or flat surface, as long as the appropriate gap AG is provided between the sensitive area 19 and the optical receptive section 20

In each case, the end face of the test instrument's ferrule 3 and 13 may be shaped such that there is a near-planar contact in the contact regions 6/7, 16/17 beginning outside the sensitive area 9/19, e.g. at a radius approximately 75 um to 200 um, ideally 125 microns from the longitudinal center axis of the DUT 2/12 or outside the core and cladding region of fiber under test. The sensitive area 9/19 of the DUT 2/12 ends at a radius of 62.5 microns from longitudinal axis, i.e. center. The sensitive area 9/19 of the DUT 2/12 may be defined, in the illustrated embodiments of FIGS. 1a and 2a, as the portion of the DUT 2/12 that may be comprised of optical fiber (core and/or cladding). The non-sensitive area may be defined as the area comprised of a mechanical ferrule 13/14, often made of zirconia.

The optically receptive section 10/20, i.e. the optical element 28, of the test instrument 1/11 employs a relatively larger (e.g. more than 2×, preferably more than 5×, more preferably more than 10×) diameter compared to the optically sensitive area 9/19 of the DUT 2/12, and a higher (at least 2×) numerical aperture (NA) to efficiently relay at least a portion of the optical power to a photodiode 30 that may be optically coupled at a distance beyond the mechanical constraints of the DUT 2/12. The diameter and NA of the optical receptive section 10/20 may be a function of the air gap AG used in the design. The optical element 28 used must relay a consistent percentage, e.g. 50% to 95%, ideally between 85% and 95%, of the DUT's optical power to be effectively used for power measurement. In the preferred embodiment, the optical element 28 used for the optical receptive section 10/20 is a 0.39 NA, 300-micron core, step-index silica fiber; however, other optical elements are within the scope of the invention. As described above, the test fiber's ferrule 3/13 may be shaped and polished to establish near planar contact in the non-sensitive region 6/7 and 16/17, i.e. at a radius of 125 microns from the optical center of the DUT 12 when the DUT 12 may be a single mode optical fiber. The air gap AG of the preferred embodiment between the optically transmitting area 9/19 and the optically receptive section 10/20 may be between 10 um and 25 um, preferably between 15 um and 20 um, and ideally 18 microns. Relayed optical power is emitted at the termination of the optical element 28 in free space to the photo diode 30. The photo diode 30 may be part of an electronic circuit which interprets the output of the optical element 28 to accurately display the power transmitted to it.

Alternatively, the optical element 28 may be comprised of the photo diode 30 and some sort of optical relaying element, e.g. fiber or lens, or the optical element 28 may consist of the photo diode 30 only, without need of any optical relaying element. In these cases, an electrical signal from the photo diode 30, encased in the test instrument ferrule 3/13, may be transmitted to a control device, e.g. hardware and software, electrically connected to the photodiode 30.

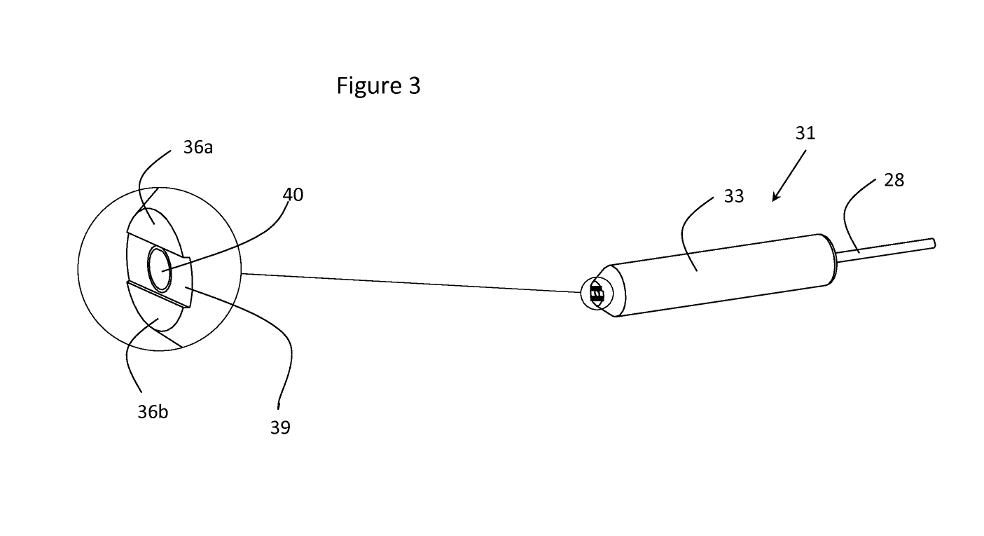

Within the two components of the design, there exist alternate embodiments that would achieve the same result and are within the scope of the same invention. With reference to FIGS. 3 to 5, the air gap AG may be produced by means of a slot or undercut defining the non-contact surface. With reference to FIG. 3, a test instrument 31 includes a test ferrule 33 surrounding the optical element 28. A generally circular end face of the test ferrule 33 includes a diametrically extending rectangular slot 39 defining the sensitive area, including the optically receptive section 40 of the optical element 28. The bottom surface of the slot 39 has a flat planar surface, perpendicular to the longitudinal optical axis of the optical element 28 and the DUT 12, and is spaced from first planar contact areas 36a and 36b, on either side thereof, by vertical walls defining the desired gap AG between the DUT 12 and the optical receptive section 40 at the end of the optical element 28. The flat planar contact areas 36a and 36b, e.g. forming segments of a circle, are for contacting the second contact areas on the end face of the DUT, e.g. two diametrically-opposed, separate planar sections of the contact area 17 on the flat DUT 12, illustrated in FIGS. 2a and 2b.

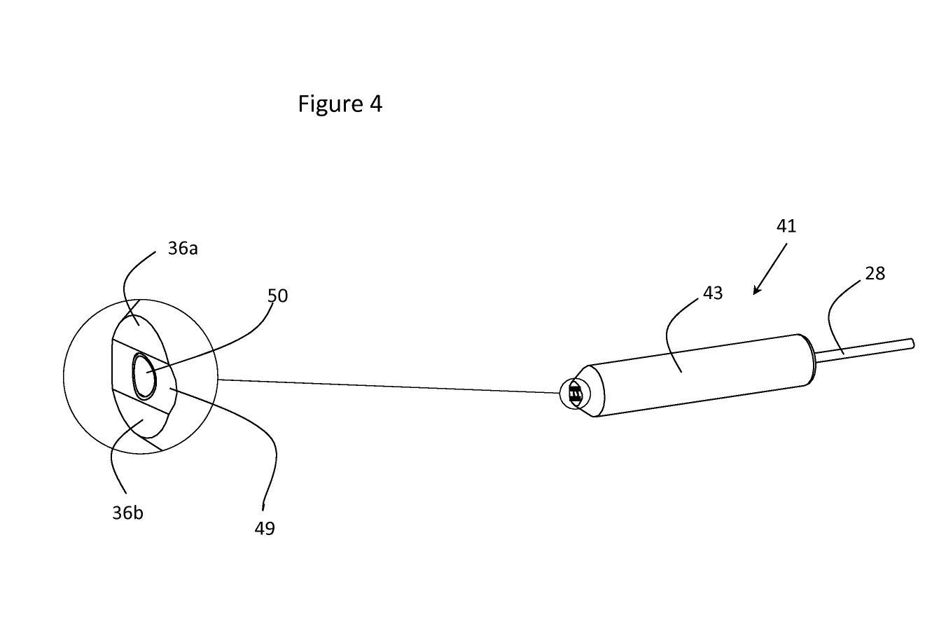

In an alternative embodiment, illustrated in FIG. 4, a test instrument 41 includes a test ferrule 43 surrounding the optical element 28. The sensitive area may be defined by a slot 49 with a curved or concave lower face, which also includes optical receptive section 50 at the end of the optical element 28. The flat planar contact areas 36a and 36b form segments of a circle, as above, provide at least one contact surface for abutting against the corresponding contact area 17 on the DUT 12, e.g. two diametrically-opposed, separate planar sections of the contact area 17 on the flat DUT 12, illustrated in FIGS. 2a and 2b.

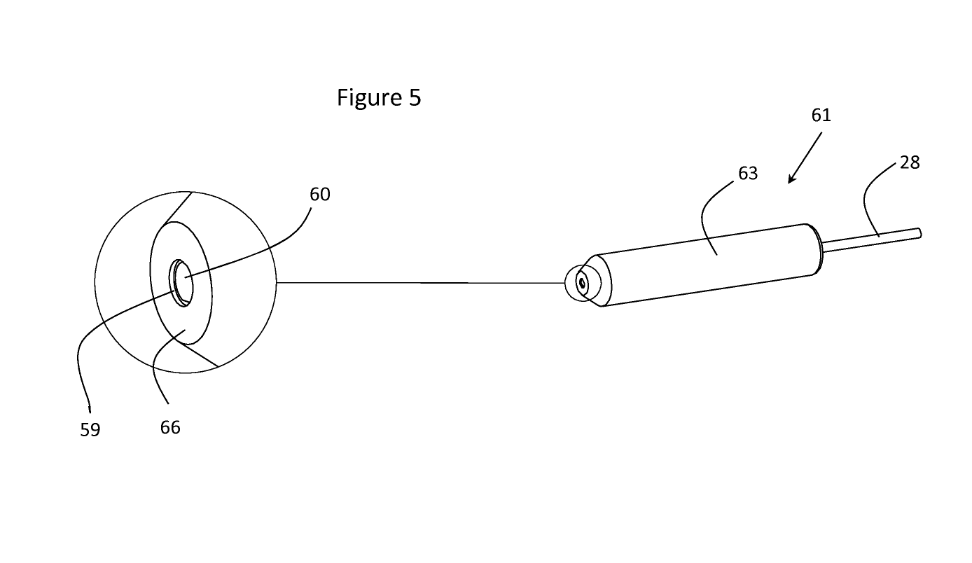

With reference to FIG. 5, a test instrument 61 includes a test ferrule 63 surrounding the optical element 28. The generally circular endface of the test ferrule 63 includes a circular recessed area defining a sensitive area 59, which includes an optical receptive section 60 of the optical element 28, surrounded by annular-shaped first contact surface 66. The gap AG between the DUT 12 and the optical receptive section 60 at the end of the optical element 28 may be defined by the annular vertical wall between the recessed area 59 and the annular shaped contact surface 66. The annular flat planar contact surface 66 provides a contact surface for abutting against the corresponding contact area 17 on the DUT 12, e.g. an annular contact area 17 completely surrounding the sensitive area 19 of the DUT 12.

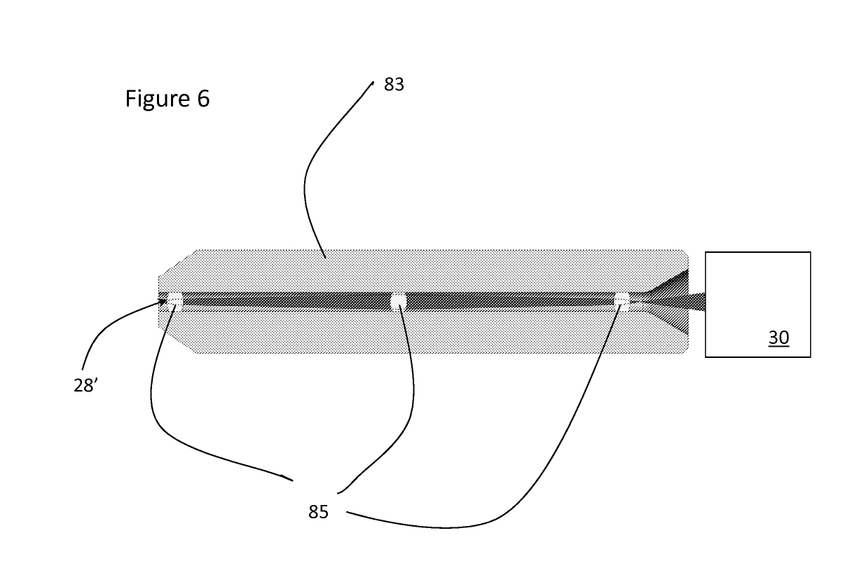

With reference to FIGS. 6, 7 and 8, the optical element 28 may take several forms other than an optical fiber. With reference to FIG. 6, a test ferrule 83 includes an optical element 28′ comprised of a plurality of relay lenses 85, space apart in a chain along the longitudinal axis of the optical element 28′ mounted in the test ferrule 83 for transmitting light to an optical fiber, optically coupled to the photodiode 30, or directly to the photodiode 30.

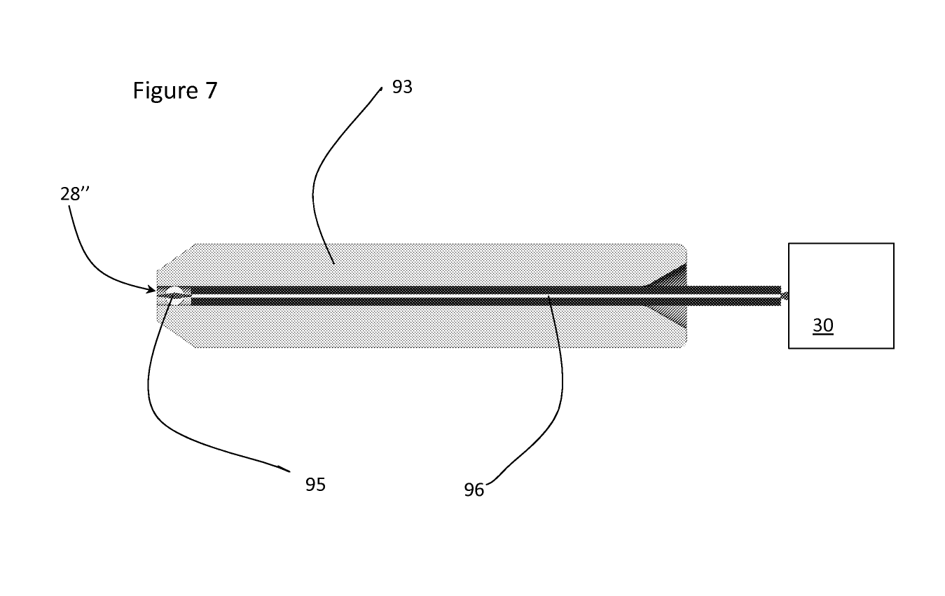

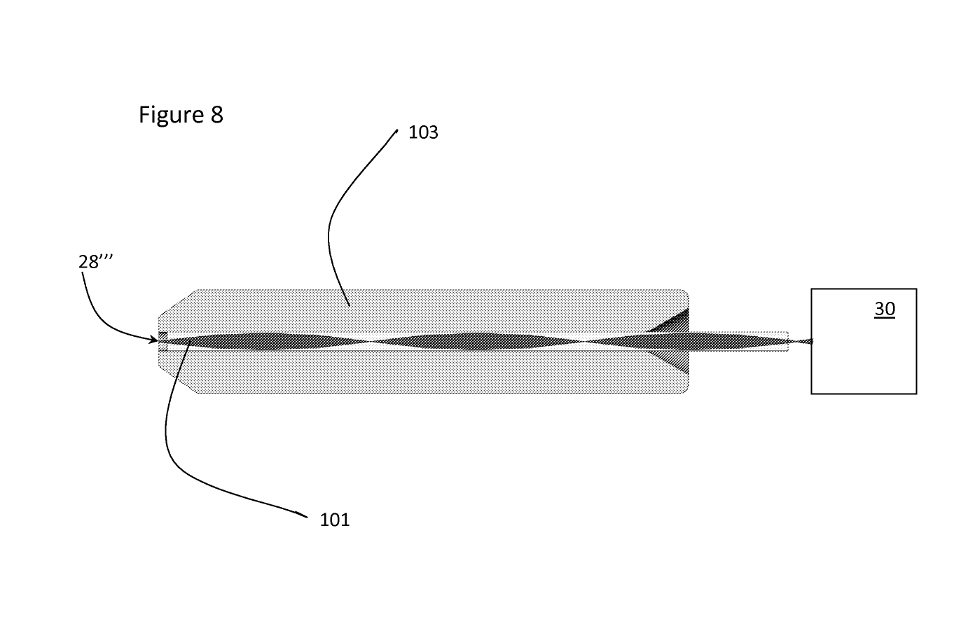

The embodiment illustrated in FIG. 7 includes a test ferrule 93 with the optical element 28″ comprised of a ball lens 95 for focusing light into an optical fiber 96 for transmission to the photodiode 30. FIG. 8 illustrates an embodiment in which an optical element 28′″ is comprised of a grin lens 101 mounted within a test ferrule 103 for transmitting light to an optical fiber, optically coupled to the photodiode 30, or to the photodiode 30 directly.

In the optical design, the optical elements 28 may be substituted by an equivalent system including (but not limited to), a GRIN lens or lenses, a ball lens/fiber combination, or a series of relay optics functioning in free space.

During use, the first contact surface 6, 16, 36a, 36b and 66 are manually brought into abutment with the second contact surface 7, 17 providing a predefined and consistent distance for the air gap AG between the optically transmitting sensitive area 9, 19, 39, 49 and 59, and the optical receptive section 10, 20, 40, 50 and 60, enabling light to be transmitted across the air gap AG at a predetermined loss, e.g. 5% to 15%, into the optical element 28 for transmission to and measurement (optical power) by the photodiode 30.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. An optical power measurement device for measuring optical power of a source of light from a device under test (DUT) comprising:
a test instrument having a longitudinal optical axis and comprising:
an optical element for transmitting test light, formed from at least a portion of the source of light; and
a ferrule surrounding the optical element; and
a photodetector for measuring the test light optically coupled to the optical element;
wherein the ferrule includes:
a first contact surface for abutting against a second contact surface on the DUT, parallel to the first contact surface, and
a non-contact surface spaced from an optically transmitting area of the DUT by an air gap when the first and second contact surfaces are abutting, the non-contact surface including an optically receptive area formed by an end of the optical element for receiving the test light from an optically transmitting area of the DUT.

2. The device of claim 1, wherein the first contact surface is at an angle with the non-contact surface, forming an acute angle between the optically transmitting area and the optically receptive area.

3. The device of claim 2, wherein the acute angle is between 5° and 15°.

4. The device of claim 2, wherein the non-contact surface is perpendicular to the longitudinal optical axis of the test instrument; and
wherein the first contact surface slopes away from the non-contact surface, parallel to an angled end face of the DUT, forming the acute angle between the optically transmitting area and the optically receptive area.

5. The device of claim 2, wherein the first contact surface is perpendicular to the longitudinal optical axis of the test instrument, and
wherein the non-contact surface slopes away from the first contact surface, parallel to a flat end face of the DUT, forming the acute angle between the optically transmitting area and the optically receptive area.

6. The device of claim 1, wherein the non-contact surface is defined by a groove in the end of the ferrule.

7. The device of claim 6, wherein the groove includes a concave lower face.

8. The device of claim 6, wherein the groove is circular-shaped surrounding the optically receptive area; and wherein the non-contact area comprises a annular-shaped area surrounding the circular-shaped groove.

9. The device of claim 1, wherein the air gap has a constant length of between 10 and 25 microns across.

10. The device of claim 1, wherein the optically receptive area of the optical element has an NA at least 2× higher than the optically transmitting area of the DUT.

11. The device of claim 1, wherein the optically receptive area of the optical element has a diameter at least 5× larger than the optically transmitting area of the DUT.

12. The device of claim 1, wherein the optical element comprises an optical fiber.

13. The device of claim 12, wherein the optical fiber has a NA greater than 0.3 and a core diameter of at least 200 um.

14. The device of claim 1, wherein the optical element comprises a ball lens, and an optical fiber.

15. The device of claim 1, wherein the optical element comprises a plurality of relay lenses.

16. The device of claim 1, wherein the optical element comprises a grin lens.

17. An optical power measurement device for measuring optical power of a source of light from a device under test (DUT) comprising:
a test instrument having a longitudinal optical axis and including a ferrule; and
a photodetector mounted within the ferrule for measuring test light, formed from at least a portion of the source of light;
wherein the ferrule includes:
a first contact surface for abutting against a second contact surface on the DUT, parallel to the first contact surface, and
a non-contact surface spaced from an optically transmitting area of the DUT by an air gap when the first and second contact surfaces are abutting, the non-contact surface including an optically receptive area formed by an end of the optical element for receiving the test light from an optically transmitting area of the DUT.

18. The device of claim 17, wherein the first contact surface is at an angle with the non-contact surface, forming an acute angle between the optically transmitting area and the optically receptive area.

19. The device of claim 18, wherein the acute angle is between 5° and 15°.

20. The device of claim 17, wherein optical receptive area of the optical element has a diameter at least 5× larger than the optically transmitting area of the DUT.
